(19) United States
(12) Patent Application Publication
(10) Pub. No.: US 2017/0229955 A1
(43) Pub. Date: Aug. 10, 2017

(54) CAPACITOR STRINGS AND APPLICATION THEREOF TO PRECISION ANALOG PERFORMANCE WITHOUT PRECISION PARTS

(71) Applicants: Robert C. Schober, Huntington Beach, CA (US); J. Daniel Likins, Tustin, CA (US)

(72) Inventors: Robert C. Schober, Huntington Beach, CA (US); J. Daniel Likins, Tustin, CA (US)

(21) Appl. No.: 15/300,189

(22) PCT Filed: Mar. 16, 2015
(86) PCT No.: PCT/IB15/51916

§ 371 Date: Sep. 28, 2016

Related U.S. Application Data
(60) Provisional application No. 61/968,291, filed on Mar. 20, 2014.

(51) Int. Cl. H02M 3/07

(52) U.S. Cl. CPC H02M 3/07

(57) ABSTRACT

Analog circuit made with digital parts can be made at deep sub-micron feature size. The use of capacitor ladders, configured to be switched from series to parallel to series electronically, permit precision outputs to be achieved without precision parts. This invention is operable in two phases, “Sample” and “Calculate (or Reference)” During the sample phase, input voltage is stored as charge, and in the calculate phase, the charges are re-arranged to perform the desired mathematical operation; while the output is expressed with a mechanism that supplies the calculated voltage at necessary current without consuming charge.

### FIELD OF THE INVENTION

This invention relates to capacitor strings (or stacks) and the application thereof to precision analog performance without precision parts.

### BACKGROUND

Nearly all digital integrated circuits require a little bit of analog circuitry to interface with the systems they are in. Since these systems do their work in the digital domain, conversion, or translation from analog to digital should be done as early as possible and allow Digital Signal Processing algorithms do the bulk of the work. Future performance demands on Digital Signal Processing will require that a digital signal processor (or “DSP”) no longer calculate, but rather approximate its results. However, when the speed of processing exceeds what a DSP can handle, the only alternative is to pre-process with analog circuits. With the continual shrink of feature size on chips, conventional analog approaches are extremely problematic to the point of failing. A new paradigm is required: “Analog-in-Digital” (or “AiD”) is such a paradigm that paves the way for the future. When an engineer can no longer perform analog circuit design, the engineer is not able to continue shrinking intact systems.

Digital complementary metal-oxide-semiconductor (or “CMOS”) integrated circuits offer certain components that have excellent analog properties:
1) Digital metal-oxide semiconductor (or “MOS”) transistors possess virtually zero input current and have an unusually small input capacitance.
2) Small, nearly ideal, Metal-Insulator-Metal (or “MIM”) capacitors (often termed cordwood or fringe capacitors) are made with interconnect traces and the same insulating material that separates those traces. The capacitance value of MIMs does not vary with applied voltage, and leakage is essentially undetectable, also their equivalent series resistance (or “ESR”) is exceptionally low. The capacitance values that are available happen to be appropriately sized for the requirements of the accompanying devices they are used with. MIMs are ideal as “Flying” (floating) capacitors, since they are not referenced to the substrate, the power supplies, or any other component in the integrated circuit.
3) The ON resistance of minimum size Transmission-Gate switches (Pass Gate logic), is not a problem because of the very minimal currents flowing in the analog path. The charge-injection error of these switches is minimized by the complementary gate drive signals used to operate them.
4) The small size components used in AiD circuits allow them to match the speed of the digital circuits they are interfaced to. Precision analog is now able to operate at digital speeds.

In modern integrated circuits there are three common choices when specifying capacitors. One uses a reverse biased semiconductor junction, another uses the capacitance between a metal-oxide-semiconductor field-effect transistor (or “MOSFET”) channel and its gate lead and the last uses an insulating oxide to separate two metalized areas. The junction type capacitor (1^{st}) varies the thickness of the dielectric (depletion region) as the voltage stored on the capacitor changes. The MOSFET capacitor (2^{nd}) also changes its capacitance value as the voltage stored on the capacitor changes. But the Metal-Insulator-Metal (MIM) capacitor (3^{rd}) does not change its capacitance as the voltage impressed on it changes, because the metal plates and the silicon-dioxide dielectric are not influenced by the voltage stored on them. For any given charge on a capacitor, if the capacitance changes so does the terminal voltage; so it is imperative for these precision circuits to use a device with a stable capacitance value.

If this same capacitor is connected in a circuit where current is allowed to flow, the charge on the capacitor is disturbed. If instead the charge on the capacitor is merely allowed to create a field in the gate region of a MOSFET, no current flows in the capacitor but the conductivity of the MOSFET channel is affected by the gate charge imposed by the capacitor. This sensing by high impedance is a key to the present invention herein described. The stored analog value remains undisturbed.

Other high impedance circuit configurations could be used to prevent the disturbance of the charge but none perform as well as a simple, unadulterated MOSFET gate. A differential pair of MOSFETS in a conventional operational amplifier (or “OP-Amp”) configuration will perform in a similar fashion but with reduced bandwidth and the OP-Amp cannot operate at all with the low power supply voltages available in deep sub-micron environments. Vacuum tubes might work as well but a short history lesson will remind us why that choice is not a good one.

Specifically, precision voltage reference without precision parts is not possible using a conventional analog design approach. For example, matched resistors are commonly used in a series connection, to provide a sequence of (analog) voltage reference output taps. This approach is costly and not even available in the integrated circuit processes where the feature size is too small to make matched resistors or even matched capacitors. A series (or stack) of capacitors, connected across a voltage reference, will offer multiple voltage outputs at regular intervals with the same precision in voltage as is the precision in capacitance. A five percent deviation in capacitance will cause a corresponding five percent error in the division of the voltage. The less than obvious solution will become obvious in the next section.

### SUMMARY

This invention is operable in two phases, “Sample” and “Calculate (or Reference)” During the sample phase, input voltage is stored as charge, and in the calculate phase, the charges are re-arranged to perform the desired mathematical operation; while the output is expressed with a mechanism that supplies the calculated voltage at necessary current without consuming charge. This cycle is repeated at the sample rate, so analog signals are processed at the rate required by the associated systems.

According to a preferred embodiment, the present invention provides an approach to analog chip design which is accomplished using integrated circuit processes, intended for digital logic, available in any digital fab. An analog value, stored as a charge on a high quality (stable) capacitor, is measured by a circuit that does not allow current flow out of that capacitor, thus preserving the analog value. Furthermore, multiple capacitors can be switched in parallel or series, as required, to perform a multitude of desirable functions.

In order to achieve precision without precision parts, a series stack of capacitors is charged, then electrically disconnected, and reconfigured to a parallel bank of capacitors. This allows the larger capacitors to equalize their terminal voltage with the lesser capacitors until all the capacitors are of equal voltage. When reconfigured to a series connection, all of the capacitors generate equal amplitude steps, regardless of their capacitive tolerance or matching. The same equalization process works in reverse, i.e. capacitors charged in parallel and then reconfigured to series. Thus the present invention provides the not so obvious answer to “analog precision without matched or precision parts”. The alternating series and parallel configuration allows use of non-precision parts as found in volume production of integrated circuits while still providing acceptable levels of precision.

Stacked capacitors provide the necessary voltage reference sources required when building analog to digital converters (or “ADC”) and digital to analog converters (or “DAC”). Finding a solution to the lack of precision parts has been the “Holy Grail” of the A to D community from the beginning. “No precision parts” allows precision analog in an environment that does not lend itself to analog precision. The results are totally scalable, stable, low power, all uncommon to analog designs. An important additional benefit is that designs are not constrained to a particular scale or vendor's manufacturing process, because the designs are assembled in a digital integrated circuit flow using existing digital computer-aided design (or “CAD”) tools.

This reparative paradigm eliminates the requirement for precision or precisely matched components while generating precision mathematical functions where an analog solution is required (such as at high speeds). Small capacitors are used with normal tolerance, which do not need to be matched or trimmed when used in circuits with effectively zero current flow. Process variation and component degradation with time or environment has negligible effect on circuit precision where there is “effectively zero current flow.”

### BRIEF DESCRIPTION OF THE DRAWINGS

The invention will now be described in more detail with reference to the accompanying drawings, in which:

FIG. 1A is a circuit schematic diagram of 2× amplifier in accordance with the present invention;

FIG. 1B is a circuit schematic diagram of 4× amplifier in accordance with the present invention;

FIG. 1C is a diagram of Non-Inverting and Inverting Analog Buffers in accordance with the present invention;

FIG. 1D is a diagram of Analog Sum and Difference in accordance with the present invention;

FIG. 1E is a diagram of Integer Multiplication in accordance with the present invention;

FIG. 1F is a diagram of Integer Division in accordance with the present invention;

FIG. 1G is a diagram of Analog Averaging in accordance with the present invention;

FIG. 2A is a schematic diagram of a simple precision voltage divider in accordance with the present invention;

FIG. 2B is a schematic diagram of a simple precision voltage dividing charge pump in accordance with the present invention;

FIG. 2C is a schematic diagram of an eight level voltage divider in accordance with the present invention;

FIG. 2D is a block diagram, including a ½ step division, in a voltage ladder of type shown in FIG. 2C;

FIG. 2E is a detail of a ½ step divider for a voltage ladder of type shown in FIG. 2D;

FIG. 3A is an improved accuracy three-stage “divider tree” in accordance with the present invention;

FIG. 3B is the initial stage voltage waveform plot of a 64 level three-stage “divider tree” in accordance with the present invention;

FIG. 3C is the intermediate stage voltage waveform plot of a 64 level three-stage “divider tree” in accordance with the present invention;

FIG. 3D is the final stage voltage waveform plot of a 64 level three-stage “divider tree” in accordance with the present invention;

FIG. 4A is a simplified block diagram of a driver circuit as may be used for the FET switches of FIGS. 1A to 1G, 2A to 2E, and 3A to 3D;

FIG. 4B is a complete block diagram of a driver circuit as may be used for the FET switches of FIGS. 1A to 1G, 2A to 2E, and 3A to 3D;

FIG. 4C is a detailed diagram of a portion of a driver circuit, as may be used for the analog FET switches of FIGS. 1A to 1G, 2A to 2E, and 3A to 3D;

FIG. 5A shows a schematic diagram of traditional complementary FET Transmission-Gate;

FIG. 5B shows a schematic diagram of an optimized complementary FET switch including the coincident switch driver of FIG. 4 with reduced charge injection, as used for an analog switch;

FIG. 5C shows a schematic diagram of precision complementary FETs, offering lower charge injection errors;

FIG. 6A, 6B, 6C show illustrative diagrams of precision (charge injection cancellation) FET switches, at various analog signal levels, as may be used in circuits shown in FIGS. 1A to 1G, 2A to 2E, and 3A to 3D; and

FIG. 7 is a schematic diagram of an “adaptive” FET switch gate drive circuit, facilitating lower turn-off charge injection.

FIG. 8 is an array of relevant integrated circuit capacitor sizes illustrating the voltage produced by a single electron and the number of electrons that produce the maximum usable IC voltage; thus defining the theoretical maximum dynamic range.

Note that for clarity in these circuit diagrams, when analog and digital signals are mixed, dashed signal lines are used for digital signals and solid lines are used for analog signals.

### DETAILED DESCRIPTION OF ILLUSTRATIVE EMBODIMENTS OF THIS INVENTION

An inverter has an input threshold voltage where, any increase in input voltage causes the output to move toward the negative supply and conversely a decrease in input voltage causes the output to move toward the positive supply.

The gain of the inverter determines how sensitive the output is to changes on the input.

If the output of the inverter is connected directly to the inverter's input, the voltage on the output will come to rest at that one unique place where the output voltage is equal to the inverse of the input voltage.

If the output, instead of being connected directly to the inverter's input, is connected in series with a displacement voltage source and the circuit completed to the inverter's input, the output voltage will be displaced by the amount on the displacement voltage source.

If the inverter input is very high impedance, no current will flow in the feedback loop, allowing a capacitor to be used as the displacement voltage source, while not disturbing the charge on the capacitor. No current flow means that tolerance variations from capacitor to capacitor do not have an effect on the total displacement voltage delivered by multiple capacitors connected in series.

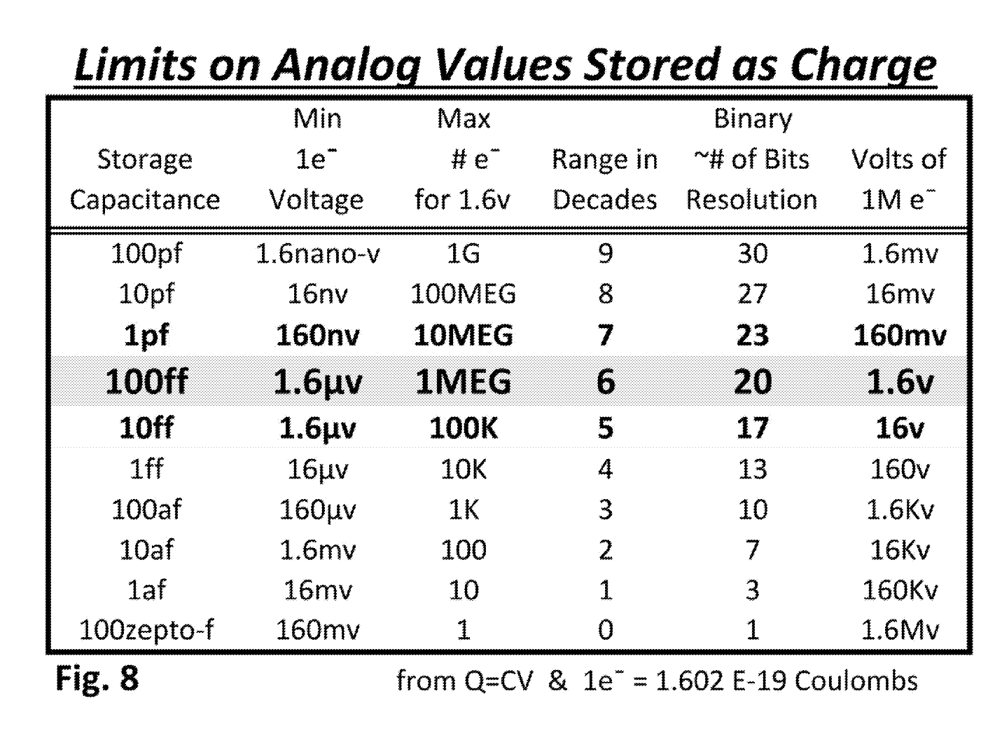

The sizes of interconnect metal capacitors available on integrated circuits are completely compatible to the accuracies and speed requirements imposed by the inverter input characteristics and transmission-gate switch characteristics for near-minimum size CMOS transistors. FIG. 8 is a table that illustrates the signal levels incurred and dynamic ranges available. For instance, a 1pf capacitor produces 160 nanovolts for each electron it stores. At power supply voltages this yields a dynamic range of about 10 million or 7 decades of dynamic range which is equivalent to 23 bits of digital resolution. 10pf provides about 8 decades of dynamic range which is 100 million or 27 bits of digital resolution. The noise floor is determined by a count of electrons not being where they are supposed to be.

The output of the inverter can deliver considerable amounts of current while the feedback loop maintains the output at the proper displacement voltage.

Since no current flows in the feedback loop, multiple capacitors can be connected in series and/or parallel (with differing polarities—if necessary) to perform a variety of valuable mathematical functions.

The inverter can be an op-amp, a digital logic gate or most any gain stage with inversion from input to output. While a high input impedance is desirable, a lower input impedance will work if the operation is quick enough that displacement voltage droop is negligible. With a high impedance input, higher open loop gain allows greater accuracy.

### 1] 2× Amplifier

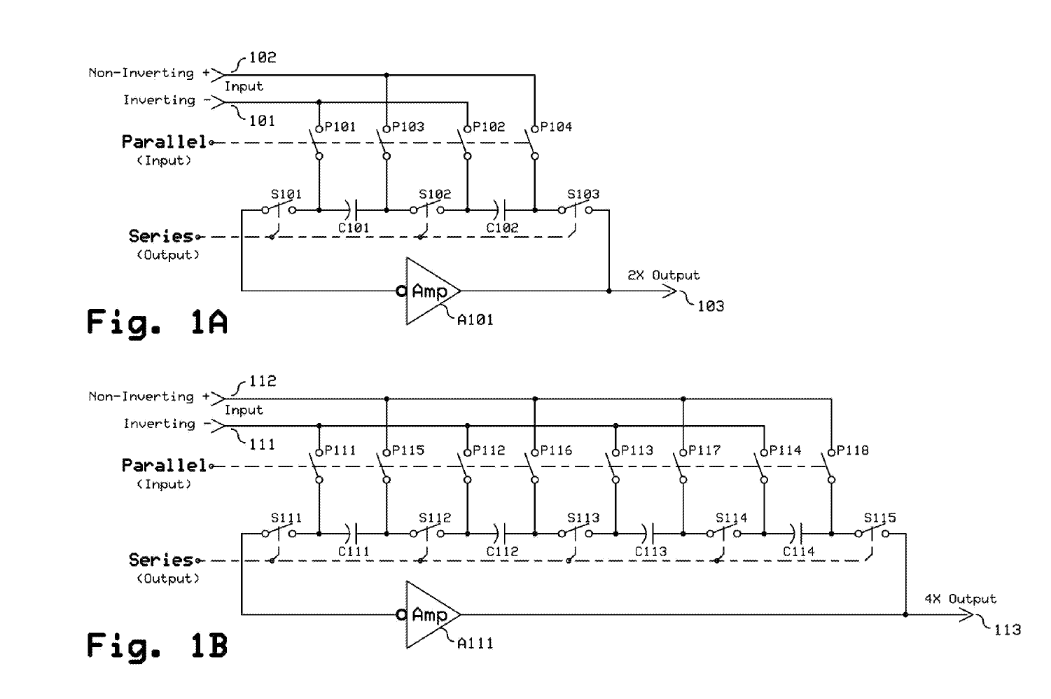

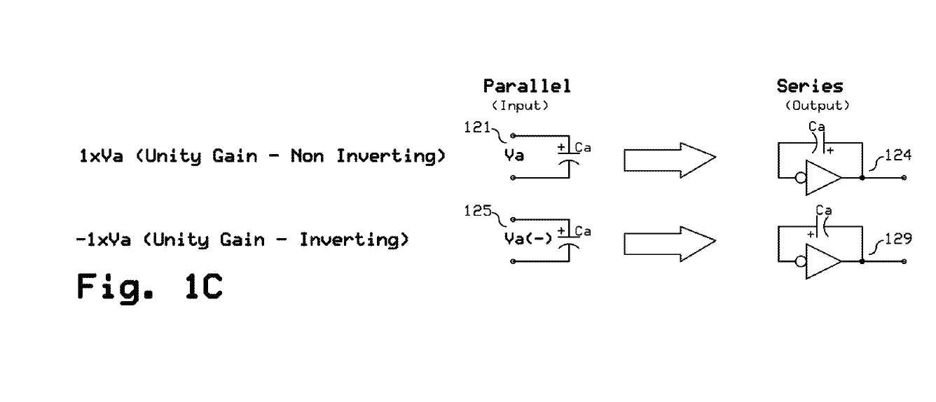

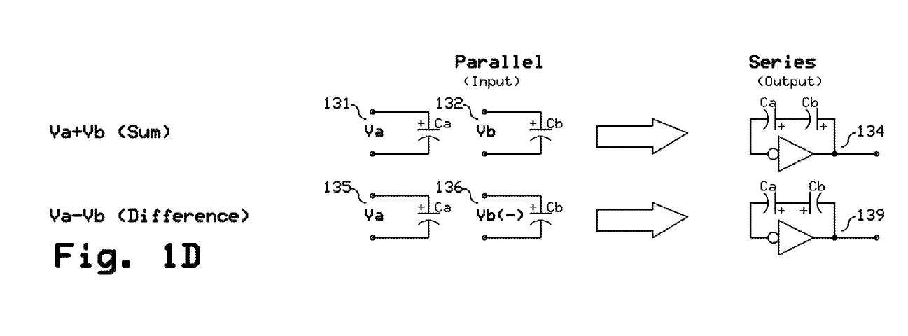

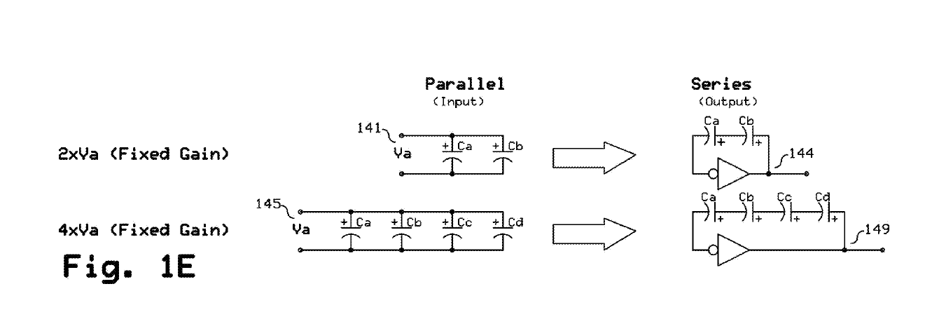

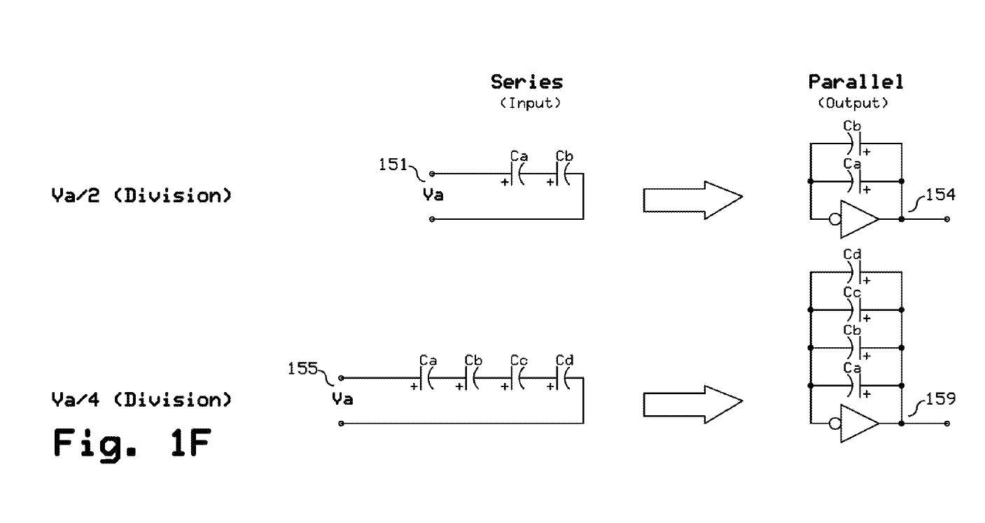

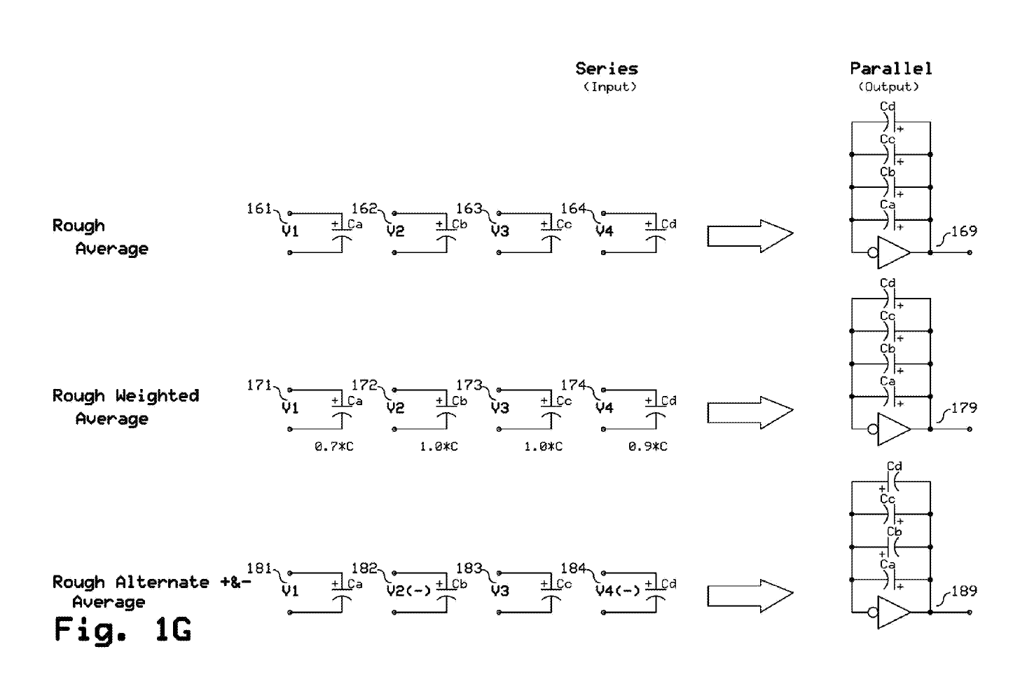

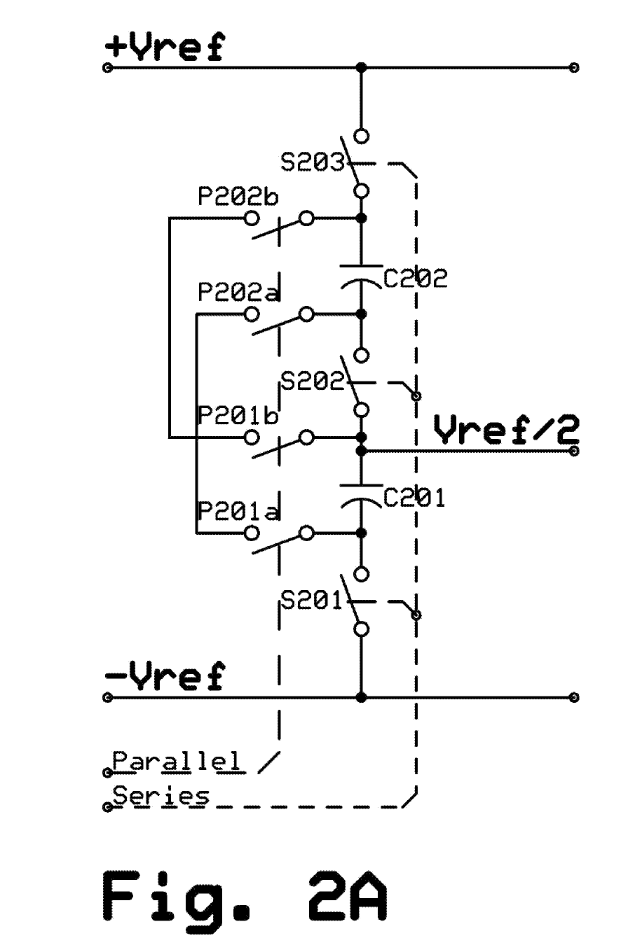

FIG. 1A illustrates a circuit comprising two capacitors C101 and C102. In the first configuration a first set of switches P101, P102 and P103, P104 are closed and connect the input 101 and 102 to either side of capacitor C101 and capacitor C102 respectively, i.e. switches P101 and P102 connects an inverting input voltage 101 to one side of the capacitors C101 and C102; while switches P103 and P104 connects a non-inverting input voltage 102 to the other side of the capacitors C101 and C102.

In the second configuration capacitors C101 and C102 are arranged in series with each other and are further in series with an inverter A101. The circuit in the second configuration includes a second set of switches S101, S102, and S103 being closed. Switches S101 and S102 are arranged to first and second sides of capacitor C101. Switches S102 and S103 are arranged to first and second sides of capacitor C102. At this time the output appears at 103, and is precisely 2× the voltage that was presented at the input 101 and 102.

The circuit operates as follows:
1. Switches P101, P102 and P103, P104 are closed allowing the capacitors C101 and C102 to charge to the voltage presented at the inverting 101 and non-inverting 102 input terminals.
2. Switches P101, P102 and P103, P104 are, then, opened. Then switches S101, S102, and S103 are closed connecting the capacitors C101 and C102 in series and placing the series string from output 103 of the invertor A101 to input of the invertor A101 as a displacement voltage. The output at 103 is precisely 2× the voltage that was presented at the input 101 and 102. In this configuration, one capacitor offers unity gain, while two capacitors offer a gain of two, and “N” number of capacitors would offer a gain of “N.”
3. It should be noted that there is complete electrical isolation between the input and output terminals.

FIG. 1B illustrates a four capacitor arrangement C111, C112, C113, and C114 for a gain of four (4). As in the description above for FIG. 1A, the circuit of FIG. 1B would be operated similarly. For example;
1. A first set of switches, P111, P112, P113, P114, and P115, P116, P117, P118 would be closed, allowing the capacitors C111, C112, C113, and C114 to be charged to the voltage presented at the inverting 111 and non-inverting 112 input terminals.
2. Switches P111, P112, P113, P114, and P115, P116, P117, P118 would then be opened, while a second set of switches S111, S112, S113, S114, and S115 are closed to connect the capacitors C111, C112, C113, and C114 in series with the invertor A111, placing the series string from output 113 of the invertor A111 to input of the invertor A111, as a displacement voltage. The output at 113 is precisely 4× the voltage that was presented at the input 111 and 112.

FIGS. 1C-1G illustrate several reference examples for analog preprocessing.

The input combinations of the constituent capacitors are shown to the left of the arrows along with the description of the arithmetic function. The output configuration of these same capacitors is shown to the right of the arrows where the constituent capacitor combinations create a displacement voltage. The amplifier is represented as an inverter with the bubble on the input to indicate that a negative signal on the input produces a positive going signal on the output.

FIG. 1C illustrates that the polarity of the output 124 or 129 depends solely on the polarity of the displacement voltage Va or Va(−) applied, based on inputs 121 or 125 and to the capacitor Ca.

FIG. 1D further illustrates that more than one input 131 and 132, or 135 and 136 can be summed by arranging the displacement voltages in series, creating an output that is the “sum” 134 or the “difference” 139 of the inputs 131 (or Va) and 132 (or Vb), or 135 (or Va) and 136 (or Vb(−)), respectively. The difference between the input voltages 135 and 136 is presented when one of the displacement voltages (in the feedback loop) is of the opposite polarity.

FIG. 1E illustrates a fixed gain configuration where the gain is equal to the number of displacement voltages arranged in series. For example, the input voltage 141 receives two times (2×) gain at the output 144; while the input voltage 145 receives four times (4×) gain at the output 149.

In FIG. 1F further illustrates that the input signal Va 151 or 155 is divided by the number of capacitors Ca and Cb, or Ca, Cb, Cc and Cd arranged in series on the input, respectively; and the parallel arrangement in the feedback loop compensates for any variations in the values of the capacitors.

FIG. 1G further illustrates various averaging arrangements, where output 169 is a rough average of inputs V1 161, V2 162, V3 163, and V4 164; output 179 is rough weighted average of inputs V1 171, V2 172, V3 173, and V4 174; and, output 189 is rough alternating +&− average of inputs V1 181, V2 182, V3 183, and V4 184. These configurations are referred to as ROUGH averages since the input voltages are from different sources. Process variations that would cause differences in the capacitors would affect the output voltage.

Output 179 is a weighted average that is dependent on the weighted value of its constituent capacitors Ca, Cb, Cc, and Cd.

Output 189 is applicable as a filter element where the various capacitors represent the samples taken at successive 180 degree intervals. The polarity reversals cause it to operate as a synchronous demodulator at the same time.

In high speed signal processing, often an approximation is sufficient. In these situations a rough average is an approximation, and while there may be an error, the error will be constant. Why do rough averaging in hardware when a DSP can perform the function with precision? The answer is that averaging in hardware much faster, thus unburdening the DSP.

### 2] Eight Output Voltage Divider

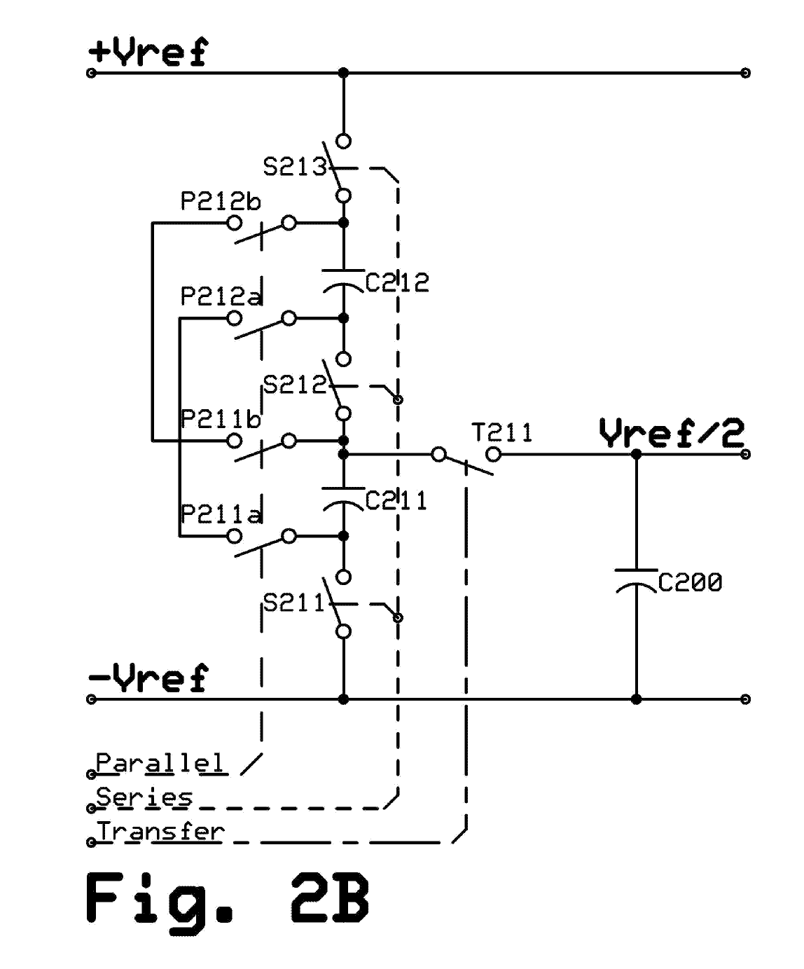

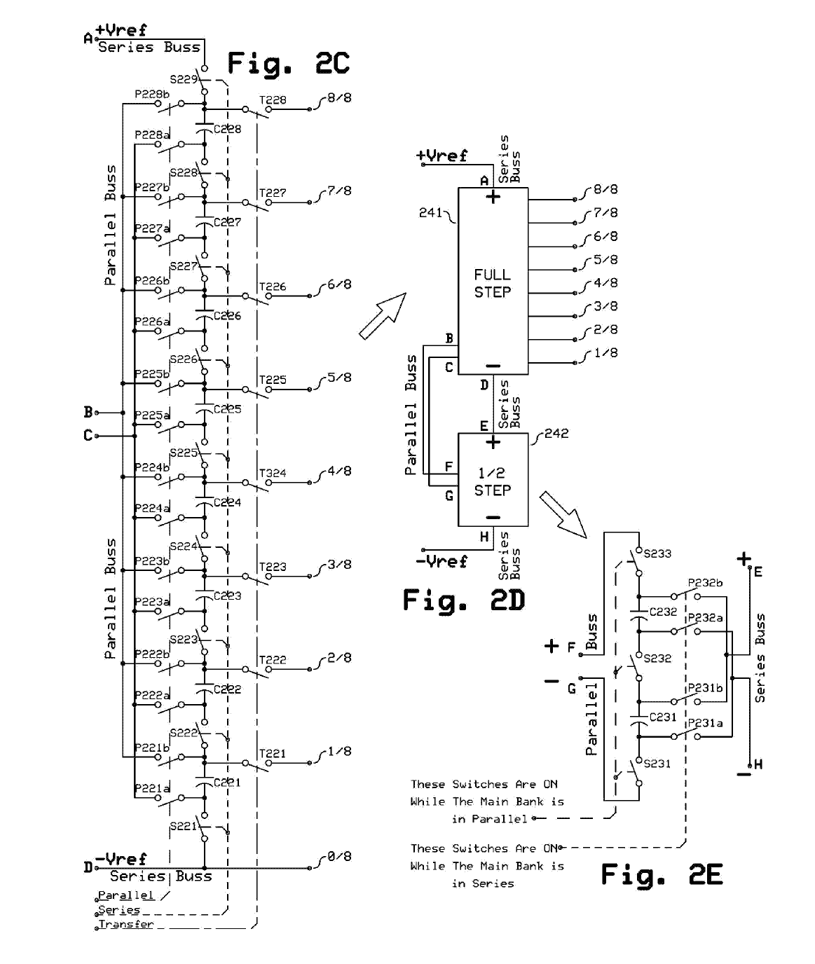

FIG. 2A shows a minimum configuration half-scale voltage ladder. The input voltages are −Vref and +Vref. The half-scale output voltage is Vref/2. The ladder is controlled by two logic signals called “Parallel” and “Series.” Initially, the series logic control line (shorter-dashed interconnect line) is active to place the two capacitors C201, C202 in series across the reference voltage inputs −Vref to +Vref. This is connected by series switches S201, S202, and S203.

This is followed by disabling the series connection and then activating the parallel connection logic signal (longer dashed line) to connect the two capacitors C201, C202 in parallel. This is connected by parallel switches P201a, P202a, and P201b, P202b. During this parallel connection time, the capacitor voltages are made precisely equal.

After the parallel connection is disabled, the two capacitors are again placed in series by S201, S202, and S203. Since the capacitor voltages were precisely equalized, the Vref/2 output voltage is exactly equal to the midpoint between the two reference voltages −Vref and +Vref. Due to the equalization step, the capacitor tolerances have no effect on the precision on the voltage division, thus precision without precision parts or process parameter drift.

Since the ladder structure of FIG. 2A is switched the arrangement of capacitors C211 and C212 between in series by the series switches S211, S212, S213 and parallel by parallel switches P211a, P211b, P212a, P212b, Vref/2 is not constant. In order to provide a constant output, a transfer switch T211 is added as shown in FIG. 2B to sub-sample the output voltage on an output capacitor C200. The logic line (dot-dashed line) named “Transfer” controls the transfer switch time, which is within the series connection time.

FIG. 2C shows a precision voltage reference generator that does not require any precision or matched parts. In similar fashion to FIG. 1A, when the series switches S221, S222, S223, S224, S225, S226, S227, S228, and S229 are closed, the voltage from the +Vref to −Vref terminals is divided across the capacitors C221, C222, C223, C224, C225, C226, C227, and C228 in proportion to their capacitance values. When the serial switches S221, S222, S223, S224, S225, S226, S227, S228, and S229 are opened and the parallel switches P221a, P221b, P222a, P222b, P223a, P223b, P224a, P224b, P225a, P225b, P226a, P226b, P227a, P227b, P228a, and P228b are closed, the capacitors C221, C222, C223, C224, C225, C226, C227, and C228 equalize any difference in their voltage, such that the stored voltage is precisely identical on each capacitor. When the switches are again operated for series connection, each of transfer switches T221, T222, T223, T224, T225, T226, T227, and T228 presents their precise division of the reference voltage, thus forming a precisely divided voltage independent of capacitor component tolerance.

### Half Step Generator

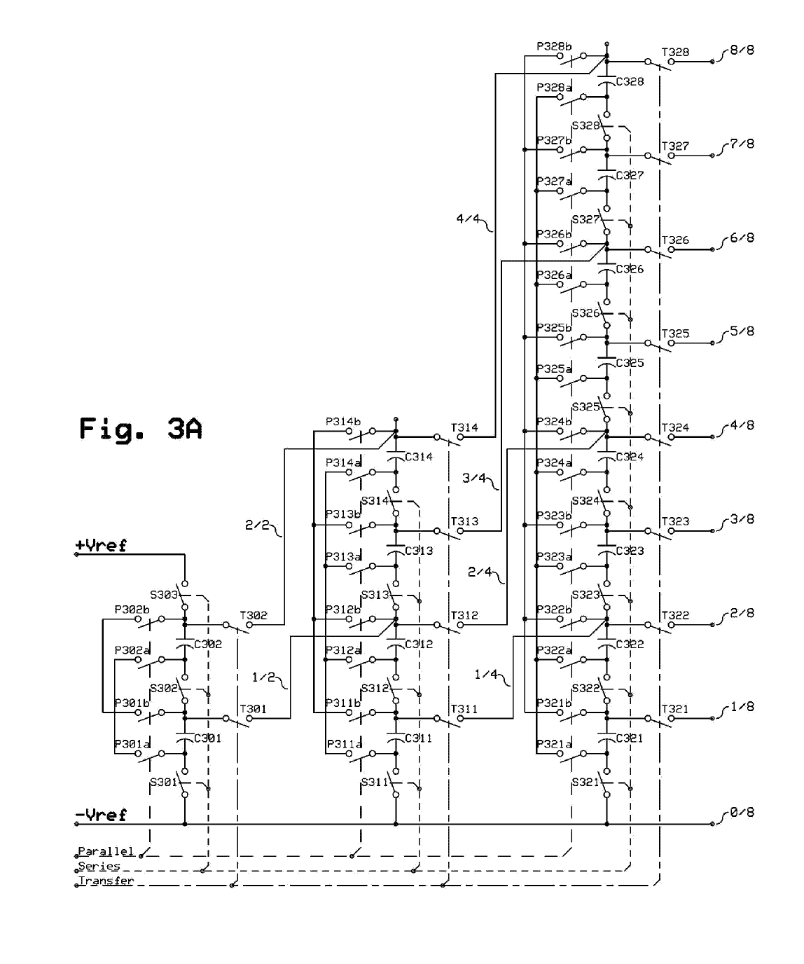

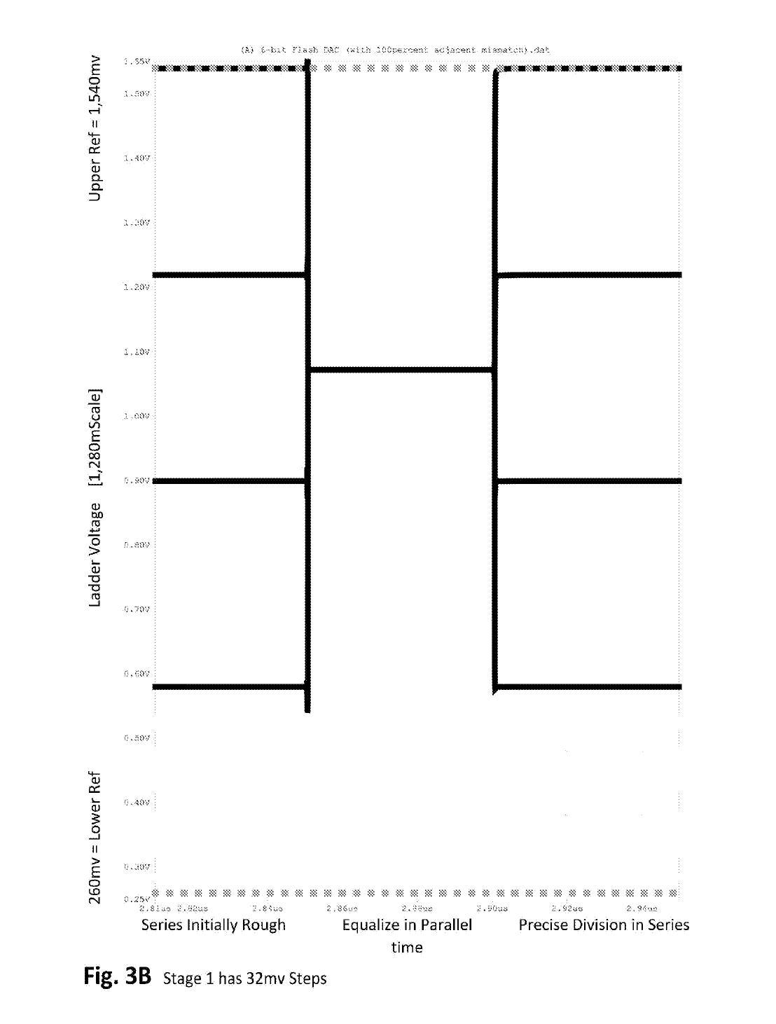

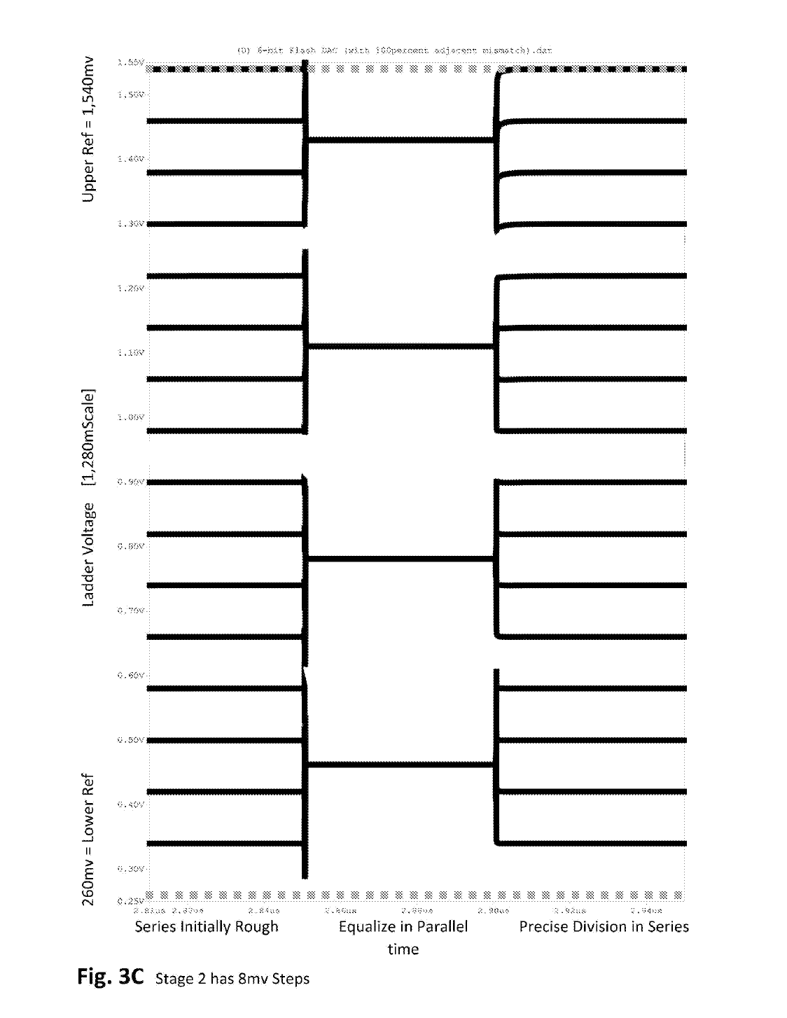

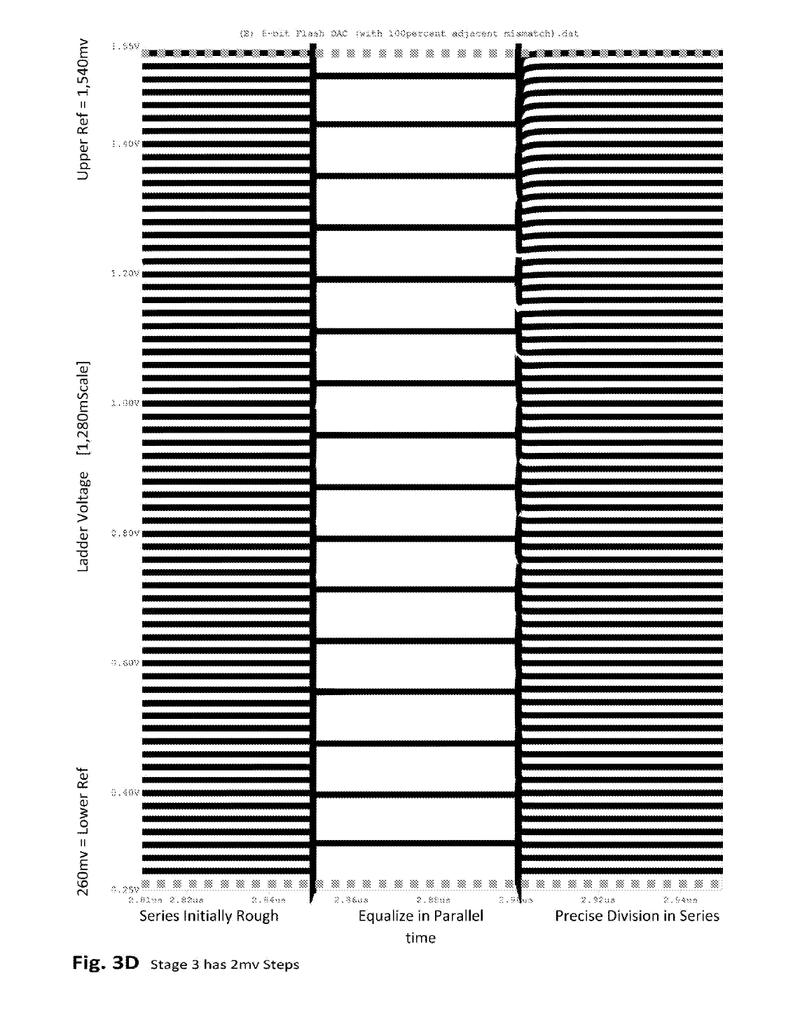

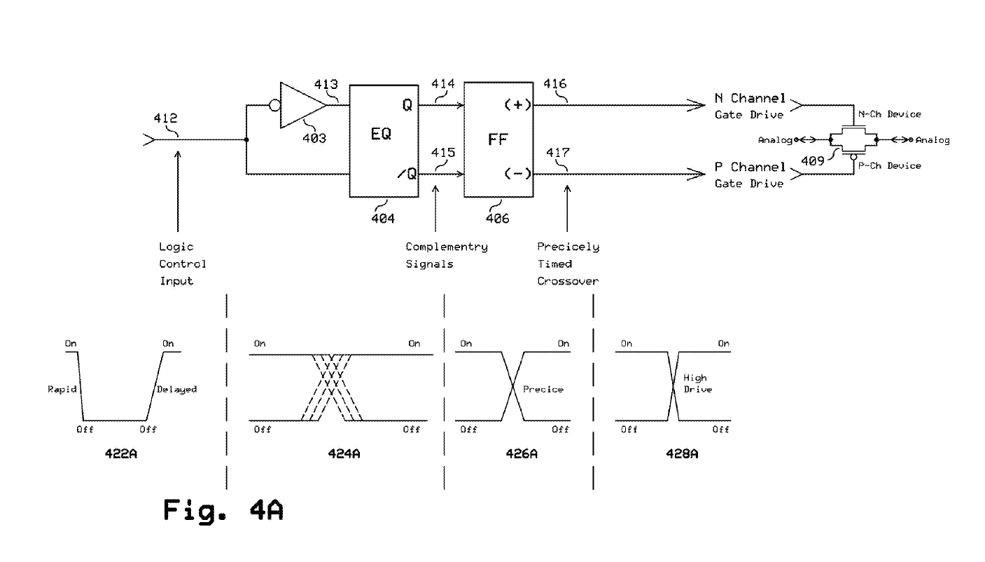

The circuits of the types shown in FIG. 2C and FIG. 3A can be offset by a ½ step by including a ½ step generator 242 as follows:

When the series/parallel capacitor stack of FIG. 2C, C221 through C228, is in the parallel configuration, the voltage across the parallel buss B & C is equal to one step. If that parallel buss voltage is presented to two other capacitors C231, C232, as shown in FIG. 2E, connected in series through switches S231, S232, and S233, each of those two capacitors C231, C232 will have ½ of the “one step” voltage present on the parallel buss. When the parallel capacitors of FIG. 2C, C221 through C228, are then connected in series and the two ½ step capacitors of FIG. 2E, C231 and C232, are connected in parallel through parallel switches P231a, P231b, P232a, and P232b, and that parallel pair in FIG. 2E is placed at the bottom of the series string of FIG. 2C (as shown in FIG. 2D) then the series voltage references on T221 through T228 are elevated to a point midway between steps where an Analog to Digital Conversion decision needs to be made, correcting for rounding errors as is well understood in the art.

### 3] Multiple Stage Voltage Reference Ladder

FIG. 3A illustrates an 8 voltage output three step version of a multiple stage reference ladder arrangement comprising an eight capacitor string C321, C322, C323, C324, C325, C326, C327, and C328, a four capacitor string C311, C312, C313, and C314, and a two capacitor string C301, C302 being similarly operative as discussed in connection with FIGS. 2C, 2D, and 2E. Each set of two or more capacitors, alternating between series and parallel connection is used to provide a set of equally spaced voltage reference sources. In FIG. 3A the series and parallel capacitor arrangements are controlled by two separate logic signals “Parallel” and “Series,” which are not both on at the same time. There is a third “transfer” logic control signal that is used to uncouple the stages from each other during the parallel equalization time.

When each series set C301-C302, C311-C314, and C321-C328 of capacitors is initially charged to an applied voltage (+Vref, “2/2,” and “4/4” all to −Vref) across their series string, the voltage across each individual capacitor is proportionally different by its capacitance value mismatch. When these charged capacitors of each previously series connected string group C301-C302, C311-C314, and C321-C328 are converted to parallel connections within each individual group, the voltage across the individual capacitors of each group is equalized to the average group voltages, because the capacitors of each group are all tied together in parallel. Thus all these capacitor voltages become precisely equal, and when these capacitors are reconnected back to their starting series connection, the divided reference voltage taps are a precise division of the applied voltage creating a precise voltage divider that is independent of component tolerance. Alternatively repeating this series-parallel-series connection sequence guarantees precisely equally divided voltages suitable for data converters and other applications. FIG. 8 suggests the available dynamic range and noise floor limits for a given size capacitor size. By using the staged voltage division of FIG. 3A with “Transfer” switches T301-T302, T311-T314 higher tolerance, or lower capacitor values may be used.

The larger input voltage (+Vref to −Vref) to be divided is sampled with the first series configured capacitor string C301, C302 through series switches S301, S302, S303 initially. This establishes a rough voltage division on these capacitors C301, C302 that has accuracy proportional to their relative capacitor C301, C302 tolerances. This operation is performed when the “Series” logic input is active.

Next, after a non-overlapping logic delay time, the “Parallel” logic signal is activated to place these capacitors C301, C302 in parallel by means of switches P301a, P302a on the bottom of the capacitors C301, C302 and switches P301b, P302b on the tops of capacitors C301, C302. Connection these capacitors C301, C302 in parallel guarantees that their voltages become exactly equal, regardless of the relative capacitor tolerances.

After another non-overlapping logic delay time, these capacitors C301, C302 are re-connected in series in the same manner as they were initially connected in series through switches S301, S302, S303, only this time these capacitors C301, C302 already had exactly equal voltages on them, thus presenting a half-scale output voltage to a transfer switch T301 and output wire 1/2. The full scale voltage is also transferred by T302 on output wire 2/2. Multiple cycles of series then parallel followed by series connections guarantee an exact half-scale voltage division. Being careful to not short any capacitor voltages together, the transfer switches present the precise voltages to the next or middle stage by means of logic control signal named “Transfer” in FIG. 3A and identified by alternating short and long dashed line.

The middle stage in FIG. 3A connects 4 capacitors C311, C312, C313, and C314 in series through switches S311, S312, S313, and S314 with the same “Series” logic control signal in a similar manner as the first stage just described. However, the voltages for the middle stage series connection are supported by the similar voltages from the previous first stage through transfer switches T301, T302. Since there is a step increase of 2 times the number of capacitors in the middle stage, each transfer voltage supports two capacitors C311, C312 and C313, C314 here. The higher CV² energy of the first stage capacitors enables the use of proportionally smaller capacitors in the middle stage. The parallel switches P311a, P312a, P313a, and P314a on the bottom of the capacitors C311, C312, C313, and C314 along with P311b, P312b, P313b, and P314b are used to connect the top of these capacitors in parallel with the “Parallel” logic control signal as in the first stage.

The third stage in FIG. 3A uses 8 capacitors C321, C322, C323, C324, C325, C326, C327, and C328 in series for an additional 2 times the divided voltage resolution. The series voltages are again supported by their previous stage through transfer switches T311, T312, T313, and T314.

The final output ladder voltages are presented to the output 0/8 through 8/8 by transfer switches T321 through T328 with the same “Transfer” logic control signal for an 8 output voltage ladder.

In each stage the parallel configuration is used for equalization of the capacitor voltages within each of the three stages. During this parallel configuration the transfer switches isolate the three stages. When the capacitor strings are re-connected in series, the output voltage is exactly equal to the desired voltage divisions. The parallel switches are identified by a prefix to their identification number, the series switches have an “S” prefix, and the transfer switches have a “T” prefix letter. The lower voltage capacitor terminal parallel switches have an “a” letter appended to their parallel switch identification number and the higher voltage capacitor terminal switches have a “b” letter appended to their parallel switch identification number.

It is desirable to minimize the size of the capacitors. At some point the effects of unavoidable surrounding parasitics causes an unacceptable error, thus establishing a lower limit on capacitor size. To address this limit, series/parallel capacitor circuits can be arranged in a tree like structure where (for example) an output level of 64 capacitors is reinforced by a prior level of 16 capacitors, which is reinforced by the initial level of 4 capacitors. FIGS. 3B, 3C, and 3D are waveforms of a 64 level 3 stage sequential ladder circuit in operation. FIG. 3B is the waveforms of the first stage which is 4 capacitor voltages, FIG. 3C is the middle stage (second stage or Stage 2) which has 16 capacitor voltages, and FIG. 3D is the third stage (or Stage 3) which has 64 capacitor voltages. The time scales and voltage scales on these 3 waveform plots are identical. This illustrative example's time scale is from 281 μs to 295 μs along the x-axis. The first or left portion of the waveforms, from 281 μs to 285 μs, represents the time spent in initially charging the capacitor strings in series. The middle portion of the waveforms, 285 μs to 290 μs, is when the capacitor banks are in parallel to equalize their voltages. The third or right portion of the waveforms, 290 μs to 295 μs is when the capacitor banks re-enter their series connections. Here all of the output voltage steps are precisely the same for each bank. The accuracy limits are consistent with FIG. 8 in that accuracies of over 30 bits are achievable, and the ladder configuration enables targeting specific voltage ranges while not building unused voltage output ranges. By re-directing the ladder hook-up, the ranges can be software controlled.

The lower dotted grey line in each plot indicates the analog zero output voltage, which is calibrated to 260 millivolts above ground. The upper dotted grey line in each plot is 1,280 millivolts above the analog zero scale voltage to represent the analog full-scale output voltage, herein calibrated to 1,540 millivolts (=260+1,280) above ground. Normally this range would be biased in the middle as analog zero and swing +640 mv (or some other appropriate range) around the analog zero bias. This calibration scheme yields 64 steps of 2 millivolt output voltage levels, proceeded with 16 steps of 8 millivolts, which is fed by the first stage of 4 steps of 32 millivolt levels. Each ascending (earlier) level makes better use of its capacitors by impressing a higher voltage on each capacitor (storing more energy per unit of capacitance [V²]), making it less affected by the parasitics. Lower energy capacitors loose some percentage of charge when being moved around from series to parallel and back to series again. Higher energy capacitors loose the same amount of charge but a lower percentage because they store more energy per unit of capacitance and therefore are less affected by parasitics (which remain constant). The tree-like structure shown in FIG. 3 overcomes this problem by transferring energy from higher voltage capacitors to lower voltage series strings of capacitors when the transfer switches are closed.

### 4] Control Signal Generation for Precision Analog Switches

When implementing precision analog switches, it is important to have rigorous control over the timing of the gate control signals. These gate control signals are complementary and need to cross each other at the midpoint between the power supply and ground to minimize control signal injection. To accomplish this, appropriately sized logic gates are used to provide signals that switch at the same time, which are fed to a final output alignment circuit that uses an “S-RAM” type flip-flop to ensure coincidence at the midpoint. This allows proper operation in the presence of reasonably expected process variations.

Often when switching between different circuit nodes, it is important that the nodes are not connected to each other, as is commonly understood in the art. To accomplish this, it is necessary to have a “Break-Before-Make” generator, which is simply a AND gate fed by the logic signal of interest and a delayed version of the same signal, as is common in the state of the art. Two to four inverters are normally adequate as the delay element, since these inverters parametrically track variations in logic speed. The precision timing of the gate drive signals to a complementary pair of MOSFET switches significantly affects the precision of the measurements that can be made. Care is therefore taken to equalize the delays in the various digital pathways.

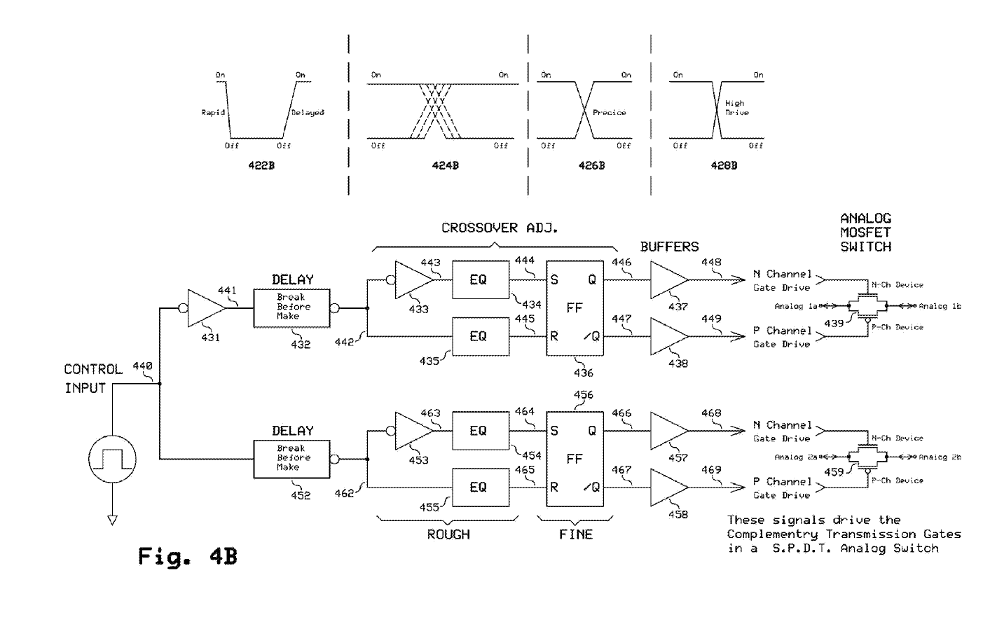

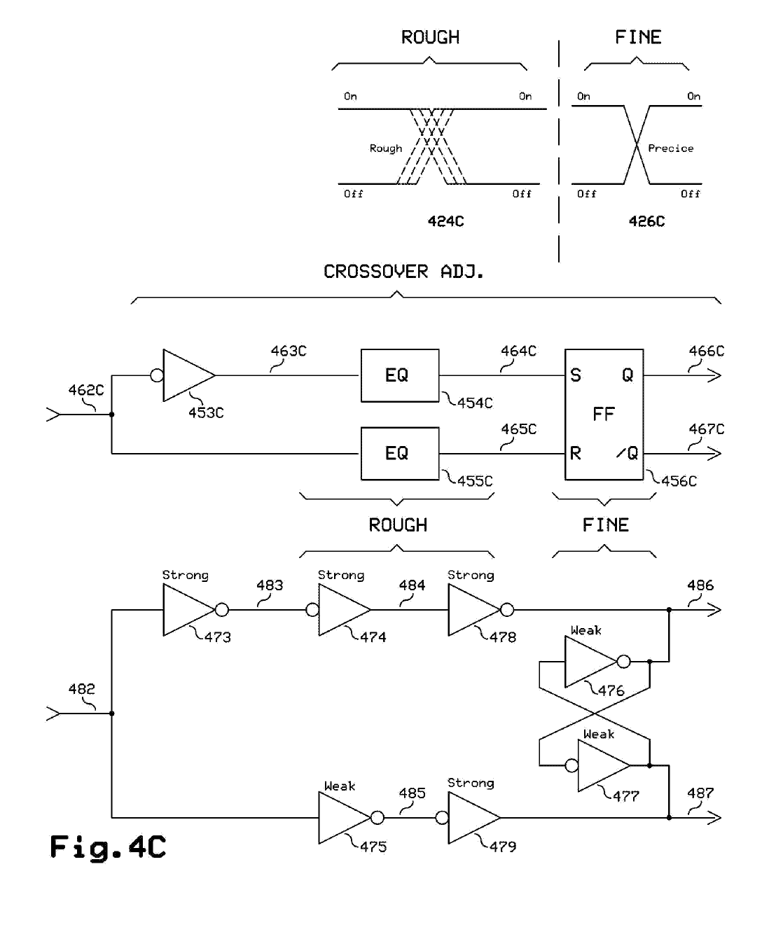

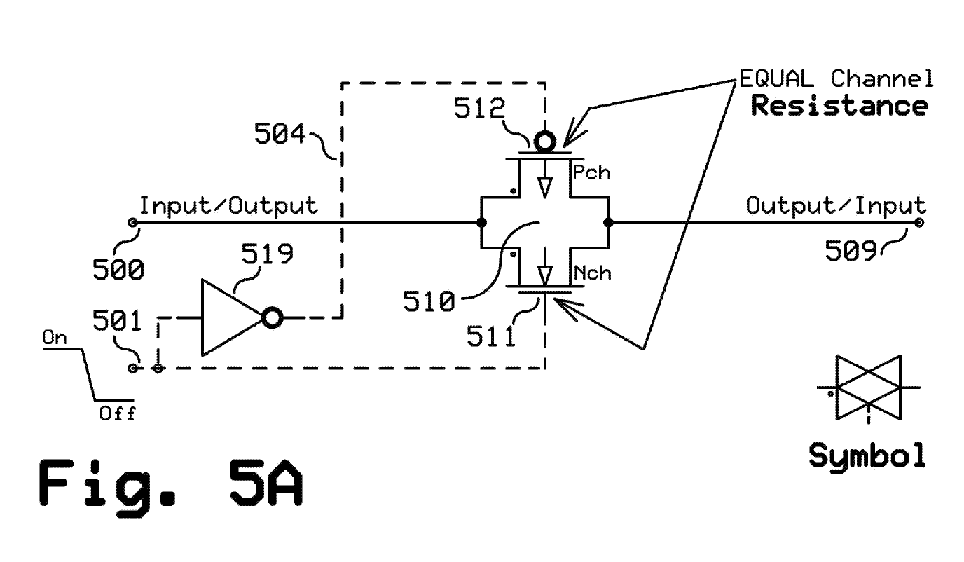

FIG. 4A shows a simplified block diagram of the complementary driver circuit for a FET switch. The incoming control signal 412, as illustrated by 422A waveform; is split into two complementary paths 412, 413 by inverter 403, then processed through an equalizer “EU” block 404 such that complementary, and roughly coincidental, outputs 414, 415 are created. Roughly coincidental is to say that the rising and falling outputs cross each other at a point approximately midway between the power supplies 424A. These signals are further guaranteed to cross at the exact midpoint 426A by a cross-coupled regenerative “FF” latch 406 where slight differences in timing from the previous stage (due to process or environmental variations) are cancelled out by the differential switching thresholds and the rapid switching rate of the latch circuit 406. The outputs of the latch 416, 417 are then buffered 428A, as required, then presented to the appropriate P-channel and N-channel gates of the FET switches 409.

FIG. 4B shows two instances of FIG. 4A where a single input signal 440, depicted by 422B waveform, controls two FET switches 439, 459 that are complementary in their operation such that when one switch is OFF, the other is ON. Specifically, “Break-Before-Make” circuits 432, 452 are found in FIG. 4B where the input signal 440 is divided into two paths, the top path 441 being inverted by inverter 431 is processed and presented at 442, the bottom path processed by 452 is presented at 462. These two signals 442 & 462 are guaranteed to NOT both be ON at the same time. This “Dead-Band” is accomplished with special logic blocks that insert a delay in the turn-on signal while passing a turn-off signal immediately. The signal is then again divided into complementary paths 442, 443, 462, 463, where the delay caused by the inverters 433, 453 in the top paths are equalized such that both signals 444, 445 are coincident and 464, 465 are coincident. The signals 444, 445 and 464, 465 at the output of the equalizers (EQ) 434 & 435, and 454 & 455 are very closely timed 424B so that the coincident rising and falling edges cross each other at a point approximately midway between the positive and negative digital power supply as best as possible, given variations in processing and environment. To further ensure the precision of this timing, the coincident, complementary signals are presented to a cross-coupled latch (FF) circuit (436, 456) where the regenerative feedback of the block adaptively addresses any timing errors that might remain 426B. Finally the signals are buffered at buffers 437, 438, 457, 458 for distribution 428B to the MOSFET switch gates 439 and 459 as required. The buffered outputs 448, 449, 468, 469 can drive a single analog switch or entire banks of switches. A conventional latch driven with a single-ended signal produces complementary outputs, but they are not precisely coincident. Driving the same latch with truly differential signals produces coincident as well as complementary outputs.

FIG. 4C shows a logic diagram of a circuit which produces the coincident differential logic drive 486, 487 from a single ended input 482. The single ended input signal 482 is inverted by an inverter 473 (giving both TRUE and NOT_TRUE signals 482, 483) and the paths are be appropriately delayed such that both the TRUE and NOT_TRUE signals 486, 487 occur as close to coincident as possible. A weakly cross-coupled latch 476, 477, having both its SET and CLEAR inputs driven at the same time will then ensure that both its outputs change at precisely the same time, such that the edges cross at mid-supply. While the input timing relationships may vary slightly with process or environment, the latch is adaptive and locks in the coincident relationship on its output.

Neither the delay technique nor the latch technique by themselves is particularly notable, but in combination they constitute a powerful way to maintain precision in the presence of a multitude of limitations.

The waveform 424C, 426C and circuit diagram 453C through 467C are reproduced from FIG. 4B for reference correlation of this more detailed logic circuitry.

### 5] Lower Charge Injection Errors for Precision Analog Switches

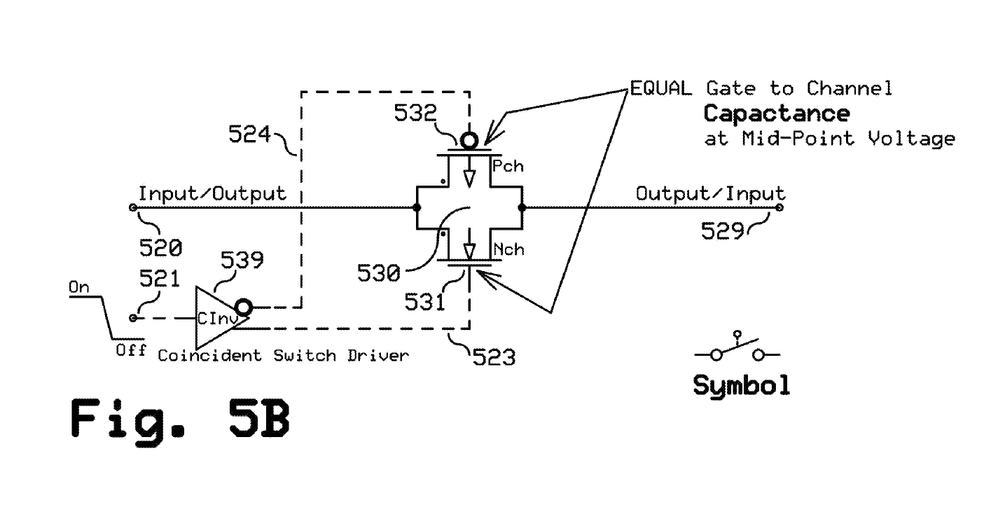

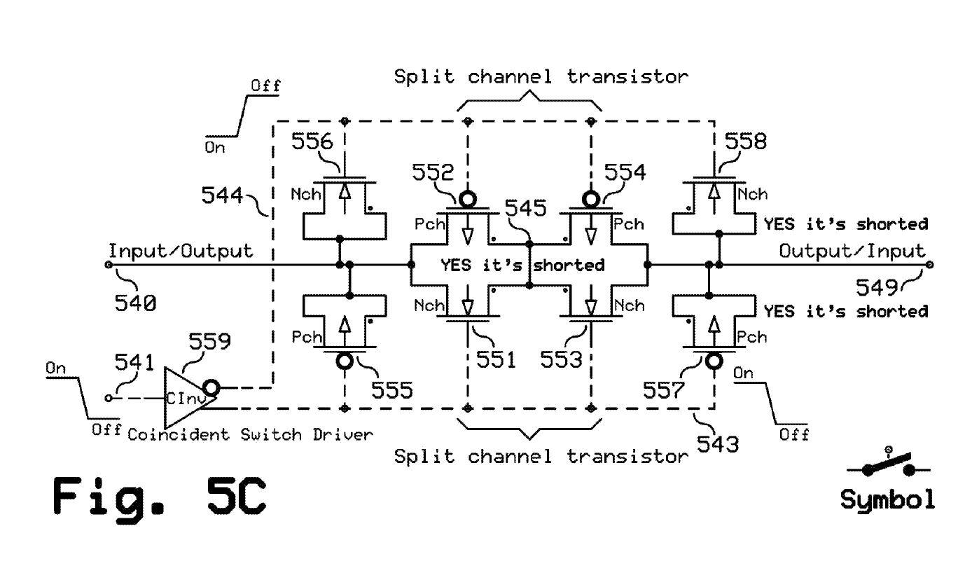

FIG. 5A shows a circuit diagram of a traditional complementary FET switch, as used for analog signals. The switch 510 is a complementary pair of CMOS transistors 511, 512 that connect or break the analog input/output terminal 500 to/from the other analog output/input terminal 509. The signal path is bi-directional in that it will pass analog signals in either direction when ON and isolate them when OFF.

The switch is operated by a logic input signal 501 and it's inverted 519 complement 504. Charge feedthrough errors are introduced during the ON to OFF transition. Equal channel resistance is used because this switch may carry significant current.

FIG. 5B shows a circuit diagram of an optimized complementary CMOS switch 530 where first order cancelation of logic feedthrough errors is made with the use of equal gate capacitance of MOS transistors 531 and 532 at the analog midpoint voltage. The driven input side 520 of the analog switch is not normally affected by charge feedthrough errors while the high impedance loaded output side 529 normally is affected by charge feedthrough errors. When the switch 530 is turned off by its logic control input 521 second order cancellation of charge feedthrough errors is made by using complementary coincident gate 539 drive signals 523 and 524 as detailed in in the description of FIGS. 4A, 4B, and 4C above. Additional cancellation of charge feedthrough errors can be made by preventing overdrive on the gate as detailed in the description of FIG. 7 below.

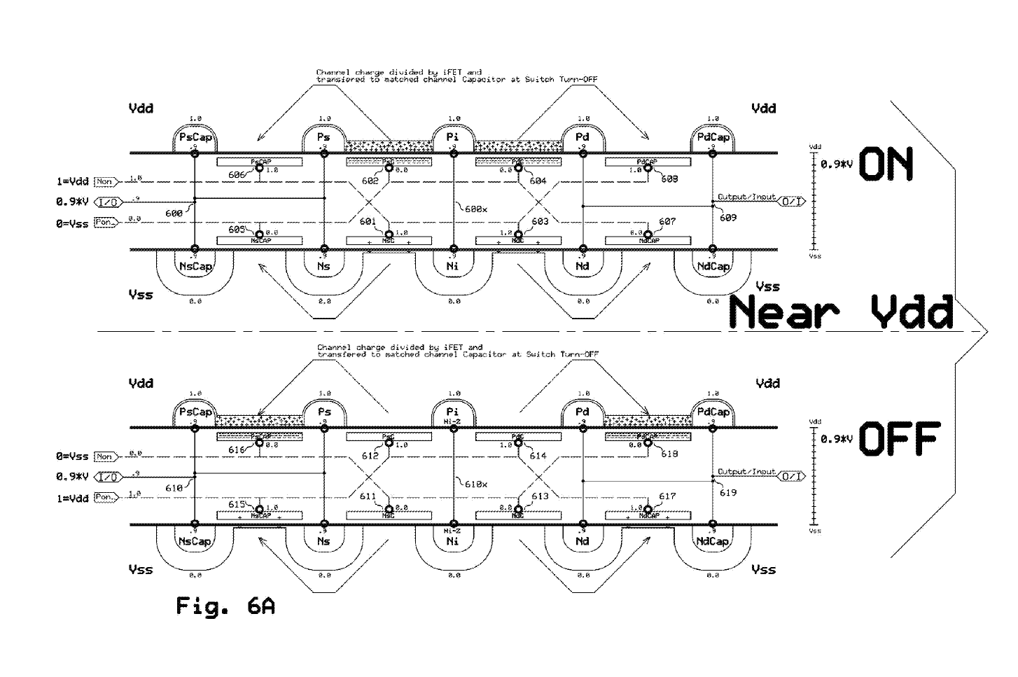

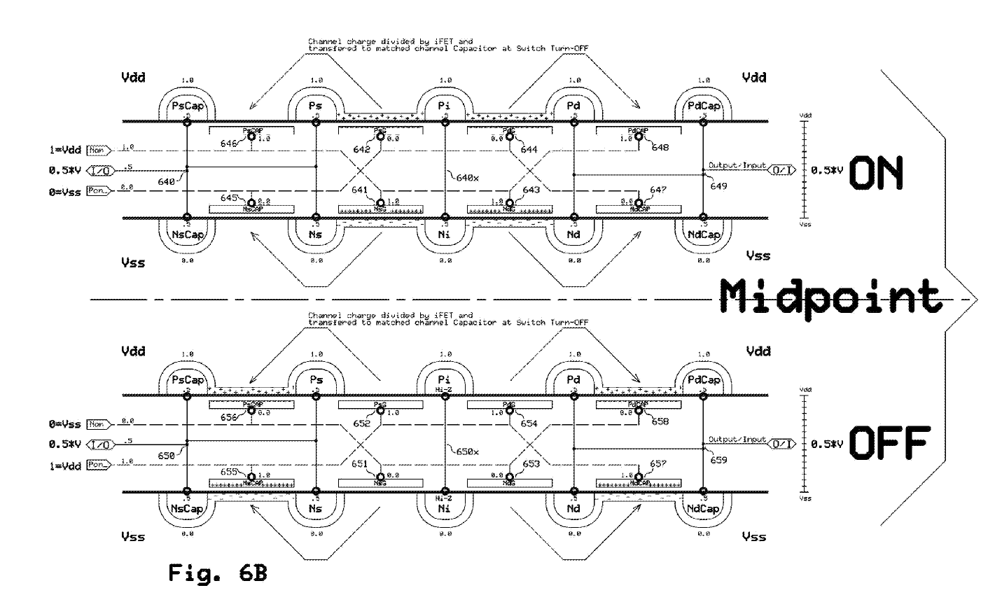

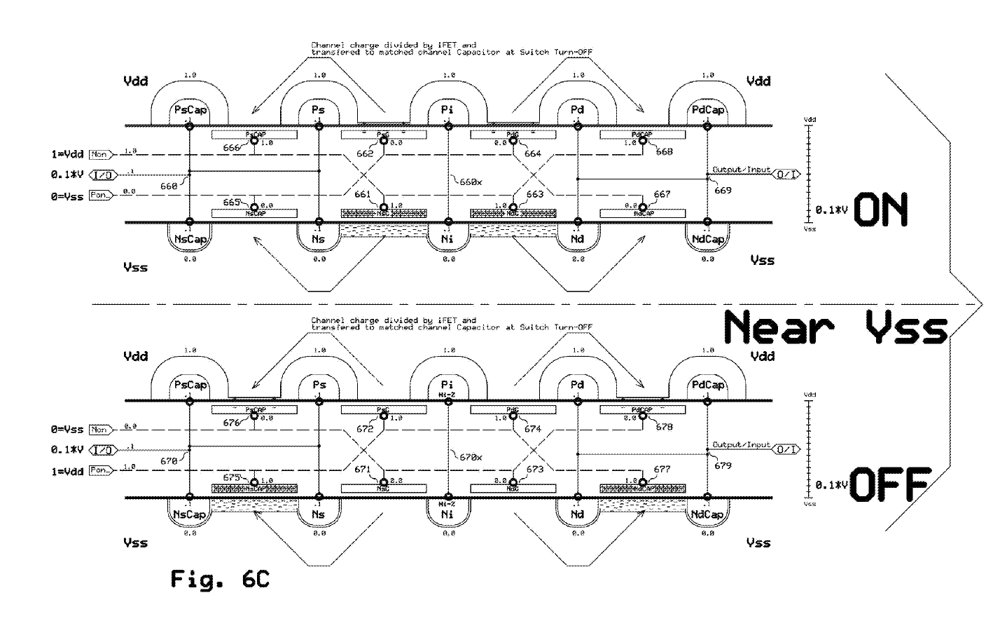

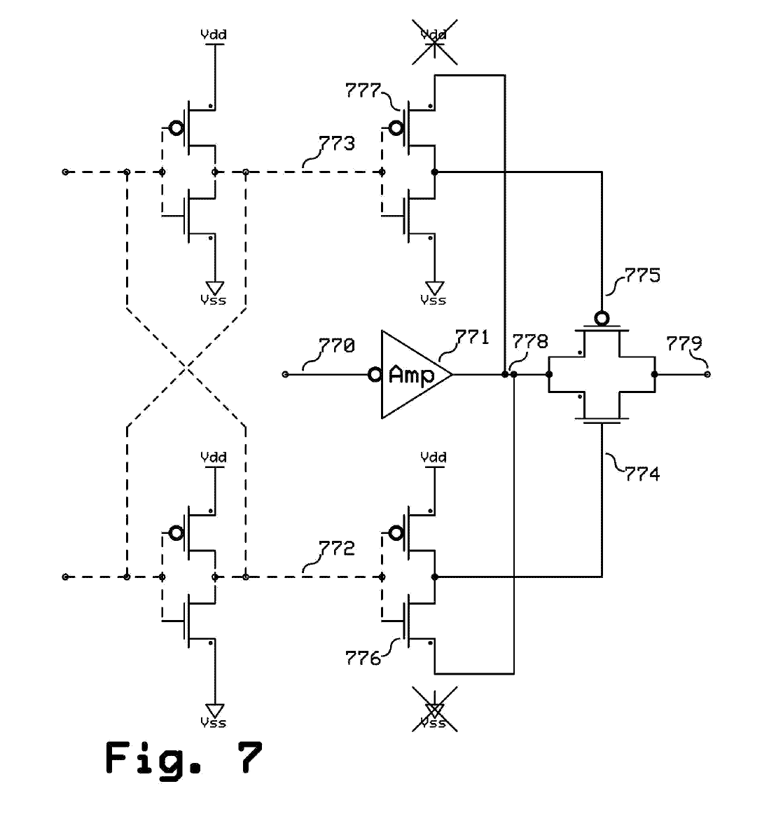

FIG. 5C is an alternative circuit, offering lower “charge injection” errors. Because of the capacitive coupling of a MOSFET gate to its channel, changes in the gate control voltage 543, 544 inject an undesirable charge into the channel. Using both a P-channel and N-channel device in parallel, making sure the gate drive 559 signals 543, 544 are complementary in phase and timing as detailed in FIGS. 4A, 4B, and 4C, somewhat improves performance. Even slight differences in the gate-to-channel capacitance of P-channel 552 and 554 and N-channel 551 and 553 devices of similar size (area) operate counter to the objective of charge cancelling. Adding additional transistors 555, 556, 557, and 558 configured as capacitors improves the otherwise mismatched situation, thus decreasing the signal injection as shown in FIGS. 6A, 6B, and 6C below.

### 6] Precision Charge-Injection Cancellation FET Switch

The charge injection problem comes from two sources. The 1st and most obvious is capacitive coupling from the gate drive signal through the gate to channel capacitance and into the channel where the signal of interest is traveling. The second and less obvious, source is the result of the reduction of the gate to channel capacitance as the channel disappears. The energy stored in the gate to channel capacitance will flow towards the path of least resistance and since the gate drive is a low impedance source, the charges flow towards the signal of interest traveling through the channel.

FIGS. 6A, 6B, and 6C are depictions of charge distribution in a transmission-gate at various operating voltages. Excess carriers create a problem when the transmission-gate is switched off. These excess carriers, in the channel, are literally squeezed out both the drain and source terminals of the transmission-gate. Additional transistors guarding the analog input and output terminals, of the transmission-gate, provide a reservoir where these excess charges can be absorbed rather than appearing as noise injected in the analog path. The amount of charge retained in the channel varies with the present analog voltage on the transmission-gate. The guard transistors have an equal but opposite charge, thus the charges cancel when the transmission-gate is switched off. In order to provide good charge cancellation, all transistors are made to be as identical to each other as practical. This includes both the switch transistors and the guard transistors. For this, the pass transistors are made up of two series transistors with their series connection nodes tied together 600x, 610x, 640x, 650x, 670x, and 680x.

In FIG. 6A, top diagram represents when the transmission-gate is switched ON while bottom diagram represents when the transmission gate is switched OFF. The operating voltage presented at the I/O terminal is at 90% of Vdd. It can be seen that when the switch is ON (top), transistors 602 and 604 are conducting and so have an abundance of carriers in the channel. When the transmission-gate is switched OFF (bottom) the guard transistors 616 and 618 absorb the excess carriers that would have otherwise been injected into the signal path. The channel charge of the ON transistors 601, 602, 603, 604 has been transferred to the empty guard transistors 605, 606, 607, 608 when the switch is turned OFF as shown with switch transistors 611, 612, 613, 614 and the guard transistors 615, 616, 617, 618.

In FIG. 6B the operating voltage presented at the I/O terminal is at 50% of Vdd. It can be seen that when the switch is ON (top), transistors 641 & 642 and 643 & 644 are all conducting and have a similar amount of carriers in their channel. When the transmission-gate is switched OFF (bottom) the guard transistors 655 & 656 and 657 & 658 absorb the excess carriers that would have otherwise been injected into the signal path. The channel charge of the ON transistors 641, 642, 643, 644 has been transferred to the empty guard transistors 645, 646, 647, 648 when the switch is turned OFF as shown with switch transistors 651, 652, 653, 654 and the guard transistors 655, 656, 657, 658.

In FIG. 6C the operating voltage presented at the I/O terminal is at 10% of Vdd. It can be seen that when the switch is ON (top), transistors 661 and 663 are conducting and so have an abundance of carriers in the channel. When the transmission-gate is switched OFF (bottom) the guard transistors 675 and 677 absorb the excess carriers that would have otherwise been injected into the signal path. The channel charge of the ON transistors 661, 662, 663, 664 has been transferred to the empty guard transistors 665, 666, 667, 668 when the switch is turned OFF as shown with switch transistors 671, 672, 673, 674 and the guard transistors 675, 676, 677, 678.

In order to cancel the undesired interference from the drive signals, it is imperative that the guard and transmission transistors be as identical as possible. It should be noted that the guard transistors have their source and drain terminals shorted so that they cannot impede the analog signal of interest. It should further be noted that the gate drive signals presented to the guard transistors are of the inverse phase as those presented to their neighboring transmission-gate transistor. In FIG. 6A the channel charge of the ON transistors 601, 602, 603, 604 has been transferred to the empty guard transistors 605, 606, 607, 608 when the switch is turned OFF as shown with switch transistors 611, 612, 613, 614 and the guard transistors 615, 616, 617, 618.

### 7] Alternative “Adaptive” Gate Drive Circuit to Lower Charge Injection Errors

FIG. 7 shows a circuit diagram of an alternative adaptive gate drive circuit to lower charge injection error. Its analog input is 770 which is amplified by amplifier 771 to derive a driven amplifier output 778. Charge injection is reduced at switch turn-off, by limiting the swing of the transmission-gate drive signals 774, 775 to the present amplifier 771 output voltage 778, instead of swinging all the way to the power supply rails. For this, transistors 776 and 777 are tied from amplifier output to their respective switch drivers 776, 775. The low impedance of the amplifier output makes it appropriate for this use. The transmission-gate transistors are both turned off because their gate to source voltage is clamped 776, 777 to zero with respect to their turn-on threshold voltage.

### Definition of Terms

The term “capacitor” herein is intended to encompass charge storage devices in general.

The term “flying capacitor” refers to a capacitor/switch combination where both ends of the capacitor are switched simultaneously and neither end is connected to a fixed node.

The term “sweet-spot” refers to the input voltage that is discovered when feedback around an inverter causes its output voltage to be equal to the inverse of its input voltage.

The term “i-FET” refers to a new FET structure where besides the standard source—drain-gate and body connections, there is a fifth low-impedance connection that allows a current rather than a gate voltage to affect the conductivity in the channel between source and drain.

The term “precision” refers to the ability to repeat a process or measurement and achieve the same resolution of results each time.

The term “logic-only process” is where the possible results are expressed as true or false.

The term “Analog-in-Digital” refers to a circuit design approach where a “logic-only process” is coerced into generating results other than true or false, specifically analog values.

What is claimed is:

1. A circuit, comprising:
i. a plurality of capacitors arranged electrically in series with a high impedance load;
ii. a first set of switches in communication with said plurality of capacitors; and
iii. a second set of switches in communication with said plurality of capacitors;
wherein said first set of switches and the second set of switches are operatively responsive to logic input;
wherein said first set of switches causes the said plurality of capacitors to be electrically connected in series, while the second set of switches causes said plurality of capacitors to be electrically connected in parallel; and
wherein the first set of switches and the second set of switches are alternatively turned on.

2. The circuit as recited in claim 1, wherein said first set of switches and said second set of switches are alternatively turned on to cause said plurality of capacitors to be electrically connected first in series, second in parallel, and third in series to yield equally divided voltages from the minimum reference voltage to the maximum reference voltage when said plurality of capacitors are electrically connected in series.

3. The circuit as recited in claim 1, wherein said second switches cause said plurality of capacitors to be electrically connected in parallel with a minimum reference voltage and maximum reference voltage.

4. The circuit as recited in claim 3, wherein said first set of switches further connects an inverter in series with said plurality of capacitors such that said first set of switches and said second set of switches are alternatively turned on in a manner to yield precisely multiplied voltages.

5. The circuit as recited in claim 4, wherein said inverter is an op-amp, a digital gate, or a gate stage with inversion from input to output.

6. The apparatus as in claim 2 further comprising one or more second switches connected between said one or more adjacent pairs of said plurality of capacitors when connected in series for outputting said precisely equally divided voltages between said minimum reference voltage and said maximum reference voltage.

7. A circuit as in claim 2 further comprising an output at each of said plurality of capacitors each of said outputs being connected to said high impedance load.

8. A circuit as in claim 1, wherein said first set of switches is activated first.

9. A circuit as in claim 1, wherein said second set of switches is activated first.

10. A method of equalizing the voltages over a plurality of capacitors connected in series with a high impedance load, said method comprising:
i. connecting said plurality of capacitors in parallel with an input voltage;
ii. subsequently connecting said plurality of capacitors in series between a high impedance load and an input voltage; and
iii. repetitively connecting said plurality of capacitors in parallel then in series.

11. A circuit having inverting and non-inverting input and output, comprising:
i. an inverter,
ii. first set and second set of switches, and
iii. first and second capacitors,
wherein said first set of switches connects said first and second capacitors in parallel with said inverting and non-inverting inputs,
wherein said second set of switches connects said first and second capacitors in series.

12. A voltage reference ladder circuit having a sampling phase and a reference phase, comprising:
i. a plurality of capacitors;
ii. a first plurality of switches; and
iii. a second plurality of switches; and
iv. an amplifier;
wherein, during said sampling phase, said first plurality of switches arrange said plurality of capacitors in series with an input voltage, then subsequently said second plurality of switches arrange said plurality of capacitors in parallel, then said first plurality of switches arrange said plurality of capacitors in series during said reference phase;
wherein the voltage reference ladder circuit further comprising one or more third switches, wherein, during said reference phase, while said first plurality of switches arranges said plurality of capacitors in series, said one or more third switches connects to between adjacent ones of said plurality of capacitors arranged in parallel for causing each of said one or more third switches to output a division of said input voltage.

13. A circuit comprising:
i. a plurality of capacitors;
ii. a first set of switches in communication with said plurality of capacitors;
iii. a second set of switches in communication with said plurality of capacitors; and
iv. an inverting amplifier;
wherein said first set of switches and the second set of switches are operatively responsive to logic input, and are alternatively turned on;
wherein said first set of switches causes each of said plurality of capacitors to receives a corresponding one of said input voltages;
wherein said second set of switches causes said plurality of capacitors to be connected with said inverting amplifier in parallel for outputting a voltage substantially average of said input voltages.
